(19) United States
(12) Patent Application Publication
(10) Pub. No.: US 2022/0089235 A1
(43) Pub. Date: Mar. 24, 2022

(54) Caravan Having an Adjustable Tongue Load

(71) Applicant: Hymer Business Development GmbH, Bad Waldsee (DE)

(72) Inventors: Ole Kasten, Stade (DE); Martin Weltjen, Oldendorf (DE); Ria Kaiser, Hamburg (DE); Mathis Wulf, Stade (DE)

(21) Appl. No.: 17/270,086

(22) PCT Filed: Aug. 23, 2019
(86) PCT No.: PCT/EP2019/072656

§ 371 Date: Nov. 29, 2021

(30) Foreign Application Priority Data
Aug. 23, 2018 (DE) 10 2018 120 688.7

(51) Int. Cl. B62D 59/04; B60K 1/04; B62D 63/06

(52) U.S. Cl. CPC B62D 59/04; B60K 2001/0444; B62D 63/067; B60K 1/04

(57) ABSTRACT

In a caravan that includes a battery and an axle, the battery is designed to supply power to a traction drive of a tractor vehicle and/or to an optional drive unit of the caravan when same is towed on the road, and the battery is mounted so as to be movable in the longitudinal direction of the caravan and can be moved by an adjustment mechanism.

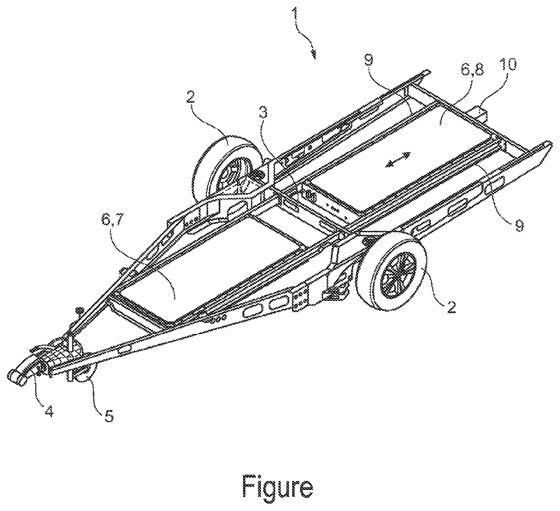

### CROSS-REFERENCE TO RELATED APPLICATIONS

This application is the United States national phase of International Application No. PCT/EP2019/072656 filed Aug. 28, 2019, and claims priority to German Patent Application No. 10 2018 120 688.7 filed Aug. 23, 2018, the disclosures of which are hereby incorporated by reference in their entirety.

### BACKGROUND OF THE INVENTION

A caravan or mobile home is a trailer for a motor vehicle, in which suitable furnishings for the occupation and habitation of persons are fitted. Such a mobile home is usually provided with a tow bar and coupling apparatus which is provided for a ball-head trailer coupling. Generally, a mobile home is a single-axle trailer or a trailer with a tandem axle. Therefore, it is decisive for the stability of the combination of the towing vehicle and the mobile home that a defined tongue load which is predetermined by the manufacturer of the towing vehicle be complied with on the trailer coupling between a minimum value and a maximum value.

In this case, particularly in the case of a mobile home, the additional problem occurs that luggage and objects are loaded in them during use. Thus, food products, clothing, etcetera, are stored in cupboards. Furthermore, sports and recreational articles, such as bicycles and the like, are often loaded in the mobile homes during the journey on holiday. The manufacturer ensures a balanced and advantageous weight distribution for the unladen mobile home in construction terms so that a desired and permitted tongue load is produced. If, however, a user loads the mobile home in an unevenly distributed manner, impermissible tongue load values may be produced. It is at least very complex and uncomfortable to place objects in the already-loaded mobile home at other locations until a permitted tongue load is reached.

However, the tongue load must be complied with precisely in the loaded state which constitutes the normal case when a mobile home is being towed. At the same time, the tongue load must not become negative in any case for reasons of travel safety and the ability to be maneuvered in the uncoupled state because this would mean that the tow bar travels abruptly upward as soon as it is uncoupled.

For comfortable and easy adjustability of the tongue load, previous proposals for solutions provide ballast which can be positioned accordingly. One possibility for this is using water tanks between which water is pumped. A disadvantage of this prior art is that ballast primarily means additional weight and at least one water supply system becomes very much more complex, even if at the same time it is a service water or drinking water system.

In the case of tandem axles, it is also known to load the suspension systems of the two axles differently in the manner of a level adjustment, for example, in a pneumatic suspension to let out air from an axle in order to achieve a different distribution of the loading of the axles. A changed tongue load is thereby also produced. Examples of this are known from DE 10 2004 003 023 B4 and EP 2 591 928 A2. However, this is not possible even in principle in the case of single-axle trailers.

DE 20 2005 017 281 U1 discloses an adjustment of the tongue load by displacing the axle relative to the trailer. However, this is very complex and expensive.

Electric vehicles or hybrid vehicles are known in the prior art, wherein, in hybrid vehicles, the drive comprises a combination of an internal combustion engine with an electric drive. In this case, the electric drive can be used in such a manner that it acts in addition to the internal combustion engine and is switched on when, in acceleration phases or when travelling uphill on an incline, an increased power is required. In this case, for example, the electric drive draws its energy from an electric energy store, in particular a battery, which is charged during uniform travel operation or during regenerative braking.

For such vehicles, there are known trailers in which energy stores, in particular large batteries or accumulators are arranged, in order to provide additional energy for the towing vehicle. The range of a purely electric vehicle can thereby be substantially increased. Such trailers are also known as “range extenders”. In this case, systems in which the trailer has an individual drive on its wheels and pushes the towing vehicle are also known.

The batteries of such trailers have a substantially higher energy content and therefore naturally constitute a relatively heavy component.

### SUMMARY OF THE INVENTION

An object of the present invention is to provide a mobile home, in which the tongue load can be adjusted simply, in particular can be adapted to a load.

### DESCRIPTION OF THE INVENTION

The object is achieved according to the invention in that, in a mobile home having a battery and an axle, the battery is configured to supply electric current to a travel drive of a towing vehicle and/or an optional travel drive of the mobile home during travel with a trailer in road traffic and is displaceably supported in the longitudinal direction of the mobile home and can be displaced by an adjustment apparatus.

If the mobile home is towed by an electric vehicle or hybrid vehicle as a trailer in road traffic, the range or efficiency thereof can be increased at peak times if, for example, via a cable connection, electrical energy from the battery is made available to the towing vehicle. As an additional variant, it is also conceivable for the mobile home itself to have driven wheels which are supplied from the battery and, in this regard, its towing resistance is reduced over long travel distances. Even if modern batteries which have a high energy density per weight are used, such batteries have a considerable weight. According to the invention the total center of gravity when the mobile home is loaded can already be changed by displaceability which is provided only over a short path in such a manner that the tongue load is in a favorable, permitted range. This advantageously allows for mobile homes a greater freedom for layout and loading concepts. It does not necessarily have to be ensured that preferred places for storing heavy luggage are located over the axle in zones which are as neutral as possible in relation to the center of gravity.

Another advantage results from the fact that tongue load limits can be complied with when relatively small vehicles are intended to pull large single-axle mobile homes and provide only a small or very small tongue load. This is particularly the case for electric vehicles and hybrid vehicles.

The battery can be connected to a toothed rack, or be supported thereon, on which the adjustment apparatus acts via a toothed wheel.

The adjustment apparatus may have a cable pull system.

In an advantageous embodiment, the adjustment apparatus has a threaded rod and nut, wherein the battery is connected to one of the two and a displacement of the battery is brought about by rotating either the threaded rod or the nut by the adjustment apparatus.

In this case, one embodiment involves the threaded rod being arranged on the battery and a nut being moved by the adjustment apparatus in order to pull or push the battery on the threaded rod. Similarly, however, it is also possible to have a transposed arrangement, in which the threaded rod is connected to the adjustment apparatus. Such a system or spindle system is self-locking. Advantageously, therefore, no additional measures are required for locking the battery in the approached position and it is securely retained.

The adjustment apparatus can be operated by a hand crank.

Advantageously, the adjustment apparatus is electrically driven and displaces the battery in accordance with an adjustment signal.

The tongue load can be detected by a sensor on the trailer coupling, in particular by a piezoceramic sensor.

In a development, an electrical control system determines the tongue load and controls the adjustment apparatus by means of an adjustment signal.

Such a control system can calculate the existing tongue load directly. It is also possible for it to display the tongue load if a suitable display or display area is provided. Via a suitable display area, an operating apparatus which is connected via cables, but also wirelessly where applicable by means of an app and a smart phone or another remote control unit, the adjustment of the tongue load can be controlled or a fully automatic adjustment can be brought about. Such an automated adjustment is user-friendly and not liable to error because the tongue load can be balanced directly with the permitted tongue load of the vehicle, for example, if a corresponding program or the app therefor provides for tables or an input possibility for the towing vehicle.

The vehicle frame can comprise external longitudinal carriers which extend in the longitudinal vehicle direction and an internal frame comprising at least partially parallel internal carriers which extend in the longitudinal vehicle direction, wherein the battery is arranged between the internal carriers in the internal frame.

The battery can be divided into a front battery and a rear battery, wherein the axle of the mobile home is arranged between them.

This internal frame which is mounted inside the vehicle frame results in an increased frame rigidity. The battery can be displaceably guided in the at least partially parallel internal carriers. The division of the battery results in an advantageous fundamental weight distribution, wherein it is generally sufficient if only one of the part-batteries is displaceable.

It is also possible to use the above-described features of a mobile home very generally in a trailer. In particular, the features which are set out in the claims for a mobile trailer can also be provided in each individual one of the claims and independently of the features of other subsidiary claims generally for a trailer.

Additional advantages and details of the invention are explained in greater detail with reference to the embodiment which is illustrated in the schematic Figure.

In this case, the Figure schematically shows a vehicle frame 1 of a mobile home according to the invention which is not illustrated in greater detail and which has the wheels 2 on an axle 3 and a coupling head 4 and a support wheel 5. A battery 6 is arranged under the floor below the bottom (not illustrated here) of the mobile home and is divided into a front battery 7 which is located in front of the axle 3 and a rear battery 8.

The rear battery 8 is displaceably supported, as illustrated by the double-headed arrow, in internal carriers 9 of the vehicle frame 1 which are parallel. An adjustment apparatus 10 can displace the rear battery 8 via a nut/threaded rod combination which is not illustrated. In this case, the rear battery 8 is fixed in its position by the self-locking. A control system detects a signal of a pressure sensor in the coupling head 4, establishes therefrom a tongue load and transmits an adjustment signal to the adjustment apparatus 10 which automatically displaces the rear battery 8 until a permitted tongue load is produced.

1. A mobile home having a battery (6, 7, 8) and an axle (3),
characterized in that
the battery (6, 8) is configured to supply electric current to a travel drive of a towing vehicle and/or an optional travel drive of the mobile home during travel with a trailer in road traffic and is displaceably supported in the longitudinal direction of the mobile home and can be displaced by an adjustment apparatus (10).

2. The mobile home as claimed in claim 1,
characterized in that
the battery (6) is connected to a toothed rack, or is supported thereon, on which the adjustment apparatus (10) acts via a toothed wheel.

3. The mobile home as claimed in claim 1 or 2,
characterized in that
the adjustment apparatus (10) has a cable pull system.

4. The mobile home as claimed in one of claims 1 to 3,
characterized in that
the adjustment apparatus (10) has a threaded rod and nut, wherein the battery (6, 8) is connected to one of the two and a displacement of the battery (6, 8) is brought about by rotating either the threaded rod or the nut by the adjustment apparatus (10).

5. The mobile home as claimed in claim 4,
characterized in that
the adjustment apparatus (10) can be operated by a hand crank.

6. The mobile home as claimed in one of the preceding claims,
characterized in that
the adjustment apparatus (10) is electrically driven and displaces the battery (6, 8) in accordance with an adjustment signal.

7. The mobile home as claimed in one of the preceding claims,
characterized in that
the tongue load is detected by a sensor on the trailer coupling, in particular by a piezoceramic sensor.

8. The mobile home as claimed in claim 7 and claim 6,
characterized in that
an electrical control system determines the tongue load and controls the adjustment apparatus (10) by means of an adjustment signal.

9. The mobile home as claimed in one of the preceding claims,
characterized in that
the vehicle frame (1) comprises external longitudinal carriers which extend in the longitudinal vehicle direction and an internal frame comprising at least partially parallel internal carriers (9) which extend in the longitudinal vehicle direction, wherein the battery (6, 7, 8) is arranged between the internal carriers (9) in the internal frame.

10. The mobile home as claimed in one of the preceding claims,
characterized in that
the battery (6, 7, 8) is divided into a front battery (7) and a rear battery (8), wherein the axle (3) of the mobile home is arranged between them.
